(19) United States
(12) Patent Application Publication
(10) Pub. No.: US 2001/0050019 A1
(43) Pub. Date: Dec. 13, 2001

(54) Heater, and an image processing apparatus using the heater

(76) Inventors: Shiro Ezaki, Kanagawa-ken (JP); Ikue Karube, Kanagawa-ken (JP); Takaaki Karube, Kanagawa-ken (JP); Masanori Fukusima, Kanagawa-ken (JP); Yukiko Fujikawa, Kanagawa-ken (JP)

Correspondence Address: PILLSBURY WINTHROP LLP, 1600 TYSONS BOULEVARD, MCLEAN, VA, 22102, US

(21) Appl. No.: 09/790,581

(22) Filed: Feb. 23, 2001

(30) Foreign Application Priority Data
Feb. 25, 2000 (JP) 2000-050184

(51) Int. Cl. B41J 2/315; B41J 2/06; B41L 35/14

(52) U.S. Cl. 101/488; 400/120.01; 347/55

(57) ABSTRACT

A heater, particularly useful for an imaging device, comprises a substrate primarily made of aluminum nitride (AlN) having an electrical insulating property. A heat generating member, formed on one surface of the substrate, contains silver (Ag) and palladium (Pd) having a weight ratio (Ag/Pd) in the range of 40/60˜50/50. Conductive electrodes are connected to respective ends of the heat-generating member.

### BACKGROUND OF THE INVENTION

1. Field of Invention

The present invention relates to a heater, particularly useful in an image processing machine such as a copier, having a substrate primarily made of aluminum nitride (AlN), and an imaging machine using the heater.

2. General Background and Related Art

Generally, an imaging machine, such as a copier, utilizes a heater for fixing toner development on a copy paper. It is desired that such imaging devices be small, and print papers quickly. Typically, a copier develops an image on a sheet of copy paper by transferring to the copy paper a pattern of toner defining the image to be developed. The toner pattern is fixed permanently to the copy paper by heating it with a heat fixing apparatus. A conventional heat fixing apparatus includes a heater and a roller arranged opposite the heater for conveying the copy paper by the heater. The heater comprises a heat-generating member formed on a substrate. The toner development is fixed on the paper by heat generated by the heater.

A heater of this type is described in Japanese Laid Open Patent Application HEI 7-201459. The heater has a substrate made of aluminum nitride (AlN), and a heat-generating member formed on the substrate. AlN is used as the material for the substrate because of its high thermal conductivity. The heat-generating member is formed by screen printing on the substrate a paste containing silver (Ag) and palladium (Pd), the paste having a weight ratio (Ag/Pd) in the range of 60/40 (1.5) to 99.7/0.3 (332.3). The ends of the heat-generating member are connected to respective electrodes, which are made of silver (Ag), an alloy of silver (Ag) and platinum (Pt), or an alloy of silver (Ag) and palladium (Pd). The alloy of silver (Ag) and palladium (Pd) is strongly glued to the aluminum nitride (AlN) substrate.

Copiers are used in various environments and with various frequencies. For example, a copier may be used often and in a room where the temperature is high. The more often the copier is used, the more heat it generates itself. Thus, the heater must function consistently under a wide range of environmental conditions and frequency of use. This is actually a problem. For example, the rate-of-change of resistance (described later) tends to rise if the amount of palladium (Pd) is too low.

Typically, the resistance value of the heater tends to be a function of its temperature. For example, when the heat generating member contains silver (Ag) and palladium (Pd) having a weight ratio (Ag/Pd) of 80/20 (=4.0), a rate-of-change of resistance with respect to heating cycles of the heat generating member becomes high, such as 20%.

In this case, the resistance value of the heat-generating member becomes higher than the designed resistance value as the temperature of the copy machine rises during the operation. As the resistance value of the heat-generating member rises, its heat production falls, which lowers the effectiveness of fixing the toner pattern on a copy paper.

The rate-of-change of resistance is calculated as follows: A first resistance value of the heat generating member is measured at the first temperature of the surrounding area, for example, out of the copy machine. Next, a second resistance value of the heat-generating member is measured at the second temperature, for example, a typical internal temperature of a copy machine during operation. A difference between the two resistance values is noted. Finally, the rate-of-change of resistance is calculated as the ratio that difference between the first and second resistance values divided by the first resistance value.

Furthermore, the temperature coefficient of resistance (hereunder TCR) of the heat generating member also tends to increase. The TCR of the heat generating member is calculated as follows: The aforementioned calculated rate-of-change of resistance of the heat generating member is divided by the difference between the first and second temperature. The TCR of the conventional heat generating member is a large number, for example, on the order of hundreds to thousands PPM/°C. Accordingly, it is difficult to generate the predetermined heat output of the heater under all possible conditions.

### SUMMARY

The inventions claimed herein, at least in one respect, feature a heater and an image processing apparatus using the heater. In one embodiment, the heater comprises a substrate primarily made of aluminum nitride (AlN) that is electrically insulating. A heat generating member, formed on one surface of the substrate, contains silver (Ag) and palladium (Pd) having a weight ratio (Ag/Pd) in the range of 40/60˜50/50. Conductive electrodes are connected to respective ends of the heat-generating member.

The inventions also include an image processing apparatus. The image processing apparatus includes an image processor for forming a toner image to be developed on a sheet of copy paper, a heater, a rubber roller arranged opposite the heater so as to be in an elastic touching arrangement with it. A housing accommodates the image processor, the heater, and the roller.

These and other aspects of the invention are further described in the following drawings and detailed description of the invention.

### BRIEF DESCRIPTION OF THE DRAWINGS

The invention will be described in more detail by way of examples illustrated by drawings in which:

FIG. 1 is a graph showing a relation between a rate-of-change of resistance of a heater and cycles of experiment according to the first embodiment of the present invention;

FIG. 2 is a front view of a heater according to the first embodiment of the present invention;

FIG. 3 is a back view of the heater shown in FIG. 1;

FIG. 4 is a section taken along the line IV-IV of FIG. 2;

FIG. 5 is a section taken along the line V-V of FIG. 3;

FIG. 6 is a section of a heater according to the second embodiment of the present invention;

FIG. 7 is a side view, partly cross section, of an image processing apparatus according to the third embodiment of the present invention; and

FIG. 8 is an enlarged cross section of a heat fixing apparatus shown in FIG. 7.

### DETAILED DESCRIPTION

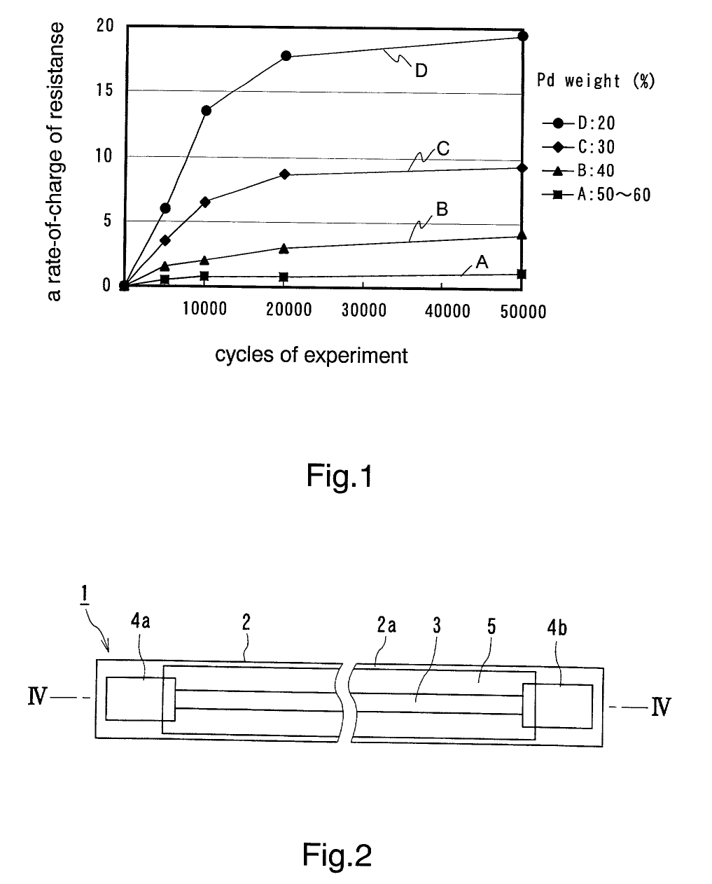

A first exemplary embodiment of the invention will be explained in detail with reference to FIGS. 1 to 5.

A heater 1, shown in FIG. 2, comprises a substrate 2 primarily made of aluminum nitride (AlN) and having an electrical insulating property. A heat-generating member 3 shown in FIGS. 2 and 4, having a length of about 230 mm and a thickness of 10 microns, is formed on a one surface 2a of the substrate 2.

The substrate 2 is formed into rectangular shape having a length of about 300 mm, a width of about 8 mm, and a thickness of 0.6 to 1 mm. The aluminum nitride (AlN) has a higher thermal conductivity, about 90 to 180 W/Mk, than that of aluminum oxide (Al₂O₃), whose thermal conductivity is 20 W/mK. Of course these dimensions are merely exemplary. Other shapes and sizes can be used. The shapes and sizes of all parts can be selected so as to be appropriate for a given size and shape of a machine utilizing the heater. When the heat generating member 3 operates, the temperature of the aluminum nitride (AlN) substrate 2 increases uniformly and quickly because of its high thermal conductivity. Because of this rapid and uniform heating, substrate 2 does not deform and strain. Generally, as the heater 1 fixes the toner pattern on the copy paper, the temperature of the substrate 2 slightly drops due to heat being conducted away from the substrate to the paper. However, the aluminum nitride (AlN) substrate 2 can quickly regain its temperature due to its high thermal conductivity. Accordingly, an image processing apparatus having a heater according to the inventions presented herein can print many pieces of paper rapidly.

The heat generating member 3, which is formed by screen printing a paste containing silver (Ag) and palladium (Pd), has a weight ratio (Ag/Pd) in the range of 40/60˜50/50. Using this range of weight ratios, the resistance value of the heat generating member 3 was tested and did not change substantially under any reasonable operating conditions. For example, a heater, such as described, was subjected to a heat cycle experiment in which the heater was repetitively turned ON and OFF at predetermined interval. One heat cycle is defined as one time of turning ON and OFF of the heater.

FIG. 1 shows a graph of a relation between a rate-of-change of resistance (plotted on the vertical axis) and heat cycles during experimental tests. A heater configuration according to the first embodiment was constructed and tested. Line A depicts the results for a generating member 3, which comprises silver (Ag) and palladium (Pd) having a weight ratio (Ag/Pd) in the range of 40/60˜50/50, according to the first embodiment. The weight ratios for the heat generating members shown in FIG. 1 are:

| Heat Generating Member | Weight Ratio Ag/Pd |
|---|---|
| A | 50/50˜60/40 |
| B | 60/40 |
| C | 70/30 |
| D | 80/20 |

The rate-of-change of resistance of the heat-generating member 3 of the first embodiment (line A in FIG. 1) is much lower than that of any of the conventional members. Furthermore, it is relatively steady over a wide range of heat cycles during the heat cycle experiment. Accordingly, the heater can accurately generate predictable calorific heat values and provide consistent heating during operation, helping to maintain high quality operation of a device utilizing heat generating member 3. The TCR of the heat generating member 3 is in a range of 100˜1000 PPM/°C. or less. Accordingly, the heater can generate predetermined calorific heat value quickly and constantly over a wide range of temperatures.

The ends of the heat-generating member 3 are respectively connected to highly conductive electrodes 4a, 4b made of silver (Ag), an alloy of silver (Ag) and platinum (Pt), or an alloy of silver (Ag) and palladium (Pd). These conductive electrodes are also formed by screen printing an alloy paste. After the paste is printed on the aluminum nitride (AlN) substrate 2, the substrate 2 having the paste is baked at about 850° C.

Conductive electrodes 4a, 4b may contain a glass and an inorganic oxide of 1 to 10 weight %. The glass not including lead (Pb) (hereafter ‘lead-less glass’) contains one inorganic oxide or more selected from a group including silicon oxide (SiO₂), aluminum oxide (Al₂O₃), calcium oxide (CaO), barium oxide (BaO), zinc oxide (ZnO), bismuth oxide (BiO₂), and boron oxide (B₂O₃). The lead-less glass made of zinc oxide (ZnO) type glass has a melting point of about 550° C. to 700° C., which is lower than the baking temperature of the paste. Therefore, when the paste is baked at the temperature of about 850° C., the lead-less glass sufficiently melts and sinks into the aluminum nitride (AlN) substrate 2 and the electrodes 4a, 4b. Therefore, the lead-less glass strongly glues the aluminum nitride (AlN) substrate 2 and the electrodes 4a, 4b.

The conductive electrodes 4a, 4b becomes porous because of the inclusion in the lead-less glass of an inorganic oxide. In case of using the aluminum nitride (AlN) substrate, when the paste of the electrodes printed on the aluminum nitride (AlN) substrate is baked at the temperature of about 850° C., nitrogen (N₂) gas occasionally generates from the substrate because of a reaction of the paste and aluminum nitride. As a result, the nitrogen (N₂) gas lies between the electrodes and the aluminum nitride (AlN) substrate, so that the electrodes and substrate glue weakly. In this embodiment, the generated nitrogen (N₂) gas passes outwardly through the pores resulting from the inclusion of the inorganic oxide. Accordingly, the lead-less glass prevent the electrodes 4a, 4b from coming off of substrate 2.

Clip-shaped connectors (not shown) coated with silver (Ag) are connected to the electrodes 4a, 4b respectively. Electrical power is supplied to the heat-generating member 3 via the clip-shaped connectors.

The surface of the heat generating member 3 and a part of conductive electrodes 4a, 4b are coated by a glassy material layer 5 having high electrical insulation. The glassy layer 5 also prevents heat-generating member 3 from being worn down and being oxidized or sulfured. The glassy layer 5 may be made of a glass of amorphous state not containing lead (Pb), which comprises ZnO—SiO_{2 or B}₂O₃—ZnO. The lead-less glassy layer is able to strongly adhere to the aluminum nitride (AlN) substrate 2.

The amorphous state glass may further include one or more oxides selected from a group of alkaline metal oxides, e.g., silicon oxide (SiO₂), aluminum oxide (Al₂O₃), boron oxide (B₂O₃) and titanium oxide (TiO₂), and alkali earth metal oxides, e.g., magnesium oxide (MgO), barium oxide (BaO), potassium oxide (K₂O), calcium oxide (CaO), lithium oxide (LiO), strontium oxide (SrO), and sodium oxide (NaO). In this case, the glassy layer 5 becomes very strong, and the surface thereof is still smooth.

When the amorphous state glass further includes inorganic oxides of 50-weight %, e.g., silicon oxide (SiO₂), aluminum oxide (Al₂O₃), zircon (ZrO₂—SiO₂), or cordierite (2MgO—2Al₂O₃—5SiO₂), the glassy layer becomes porous. In this case, the aforementioned generated nitrogen (N₂) gas passes outwardly through the pores of the glassy layer. Accordingly, the glass can prevent the heat-generating member 3, the electrodes 4a, 4b, and the glassy layer 5 from coming off the substrate 2. However, when the inorganic oxide amounts to over 50-weight % of the glass, the glassy layer becomes weak. Thus, excessive inorganic oxide makes the structure of the glass layer unstable.

Moreover, when the expansion coefficient of the glassy layer is smaller than that of the substrate, the compressive stress exists in the glassy layer and the opposite stress exists in the substrate. That is, the glassy layer is formed on the surface of the substrate by baking at the temperature of about 850° C. After the glassy layer and the substrate are baked, the temperature of the glassy layer and the substrate decreases gradually. The glassy layer having a relatively small expansion coefficient shrinks a small quantity. However, the substrate, having a larger expansion coefficient, e.g., 4.5* 10⁻⁶/°C., than the layer, contracts a larger quantity than that of the glassy layer. Accordingly, the opposite stresses occur in each material. In this case, when the heat generating member operates, the temperature of the glassy layer and the substrate rises, so that the glassy layer and the substrate starts to expand. As a result, the stresses begin to relieve, so that the glass layer does not brake during operation. Furthermore, in view of the reduced stress, the substrate does not deform.

The glassy layer, having an expansion coefficient different from that of the substrate, may cover both surfaces of the substrate. In this case, if the substrate expands by the heat generated by the heat-generating member, the inner stress between the glassy layer and the substrate occurs almost the same at each side of the substrate. Also, when the expansion coefficient of both the glass layer, e.g., borosilicate glass (3*10⁻⁶/°C.), and the substrate (4.5*10⁻⁶/°C.) is small, the substrate does not easily deform.

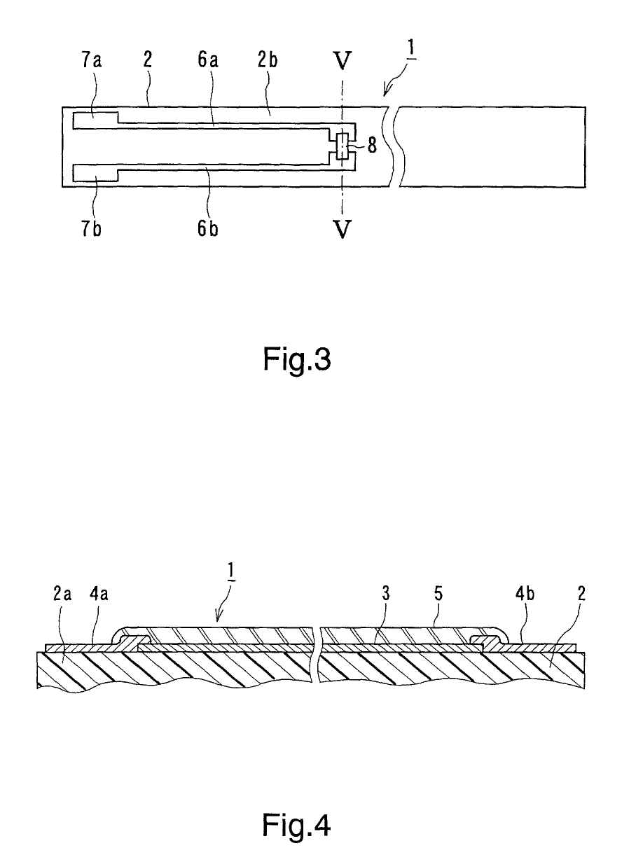

FIG. 3 is a back view of the heater shown in FIG. 1. The substrate 2 has a pair of wire patterns 6a, 6b on its back surface 2b. The wire patterns 6a, 6b, which are made of a metal selected a group of silver (Ag), platinum (Pt), gold (Au), an alloy of silver (Ag) and platinum (Pt), and an alloy of silver (Ag) and palladium (Pd), have a thickness of 10˜30 microns. One end of each of wire patterns 6a, 6b is formed into terminals 7a, 7b, respectively. The other ends are connected to a thermistor 8, which is located at the center of the substrate 2 and on the opposite side of the heat-generating member 3.

The thermistor 8 detects the temperature of the heat-generating member 3. The detected temperature is used to generate a feedback signal. A circuit (not shown) for controlling temperature of the heat generating member 3 can maintain the temperature constantly by using the feedback signal.

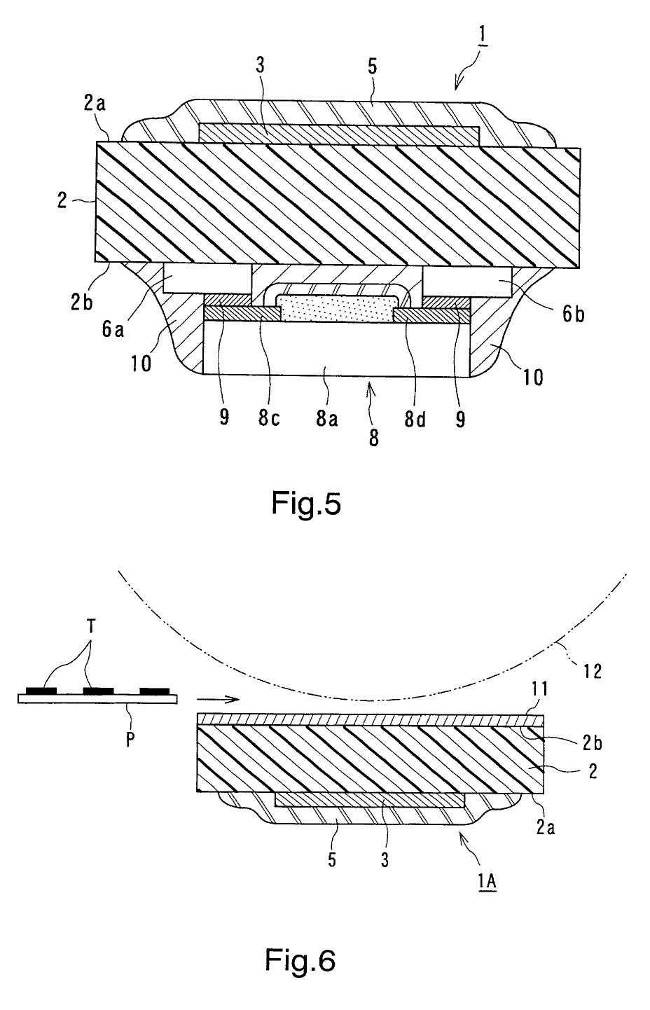

FIG. 5 is a section taken along the line V-V of FIG. 3. The thermistor 8 comprises a body 8a and a pair of electrodes 8c, 8d connecting wire patterns 6a, 6b, respectively by means of a conductive adhesive agent 9. The adhesive agent is made by mixing an organic adhesive agent with silver (Ag), or an alloy of silver (Ag) and palladium (Pd). Furthermore, an epoxy or polyimide adhesive 10 coats wire patterns 6a, 6b, conductive adhesive agent 9, and electrodes 8c, 8d.

The glassy layer 5 is arranged to an opposite side of an elastic roller 12 (not shown in FIG. 5) so as to touch it. Roller 12 carries a sheet of copy paper having a toner development image thereon between the glassy layer 5 and the roller 12. The toner development becomes fixed by the heat from heater 1.

FIG. 6 shows a section of the heater according to a second embodiment of the present invention. Heater 1A has an insulated metal oxide layer 11 on the back surface 2b thereof instead of the thermistor 8, as in the first embodiment. In this embodiment, the thermistor (not shown in FIG. 6) is arranged on the surface 2a of the substrate 2. The other elements of the heater 1A are substantially the same as the first embodiment. The insulated metal oxide layer 11, which is made of an organometal compound containing one or more selected from a group including silicon oxide (SiO₂), aluminum oxide (Al₂O₃), magnesium oxide (MgO), calcium oxide (CaO), strontium oxide (SrO), barium oxide (BaO) titanium oxide (TiO₂), zirconium oxide (ZrO₂), boron oxide (B₂O₃), and bismuth oxide (Bi₂O₃), has a thickness of about 0.1˜2 microns, a smooth surface and low heat insulating property.

Metal oxide layer 11 is arranged at an opposite side of elastic roller 12 (shown in FIG. 6) so as to touch it. When rotating, roller 12 carries a sheet of copy paper P having a toner development image T thereon between layer 11 and roller 12. The toner development T is fixed by heat from heater 1A having heat-generating member 3. Because the insulated metal oxide layer 11 has a smooth surface and high heat conductivity, the paper P can be smoothly carried by the roller 12 and the toner development T can be fixed on the paper P with certainty.

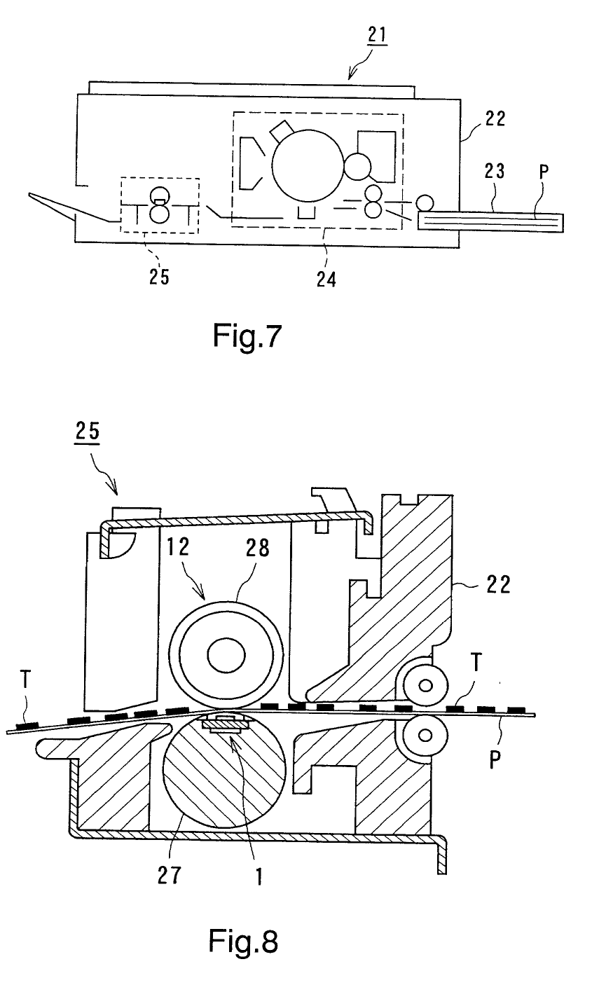

FIG. 7 shows a side view, partly cross section, of an image processing apparatus according to a third embodiment. FIG. 8 shows an enlarged cross section of a heat fixing apparatus shown in FIG. 7.

The image processing apparatus 21, for example a copy machine, comprises a tray 23 holding pieces of copy paper P, an image processor 24, a heat fixing apparatus 25, and a housing 22 surrounding the image processor 24 and the heat fixing apparatus 25.

The heat fixing apparatus 25 is provided with the heater 1 fixed in a hollow 28 of a columnar shaped holder 27. Roller 12 has a silicone rubber surface and is arranged opposite to heater 1 so that the roller and heater can elastically touch each other. A pair of electrodes 4a, 4b of the heater 1 is connected to terminals made of phosphor bronze arranged in the heat fixing apparatus 25. Accordingly, when the heater 1 operates, the aluminum nitride (AlN) substrate 2 can quickly and uniformly increase its temperature and fix the toner development T of the paper P.

What is claimed is:

1. A heater, comprising:
a substrate primarily made of aluminum nitride (AlN) and having an electrical insulating property;
a heat generating member, formed on one surface of the substrate, containing silver (Ag) and palladium (Pd) having a weight ratio (Ag/Pd) in the range of 40/60˜50/50; and
a pair of conductive electrodes, one connected to each end of the heat generating member respectively.

2. A heater according to claim 1, further comprising:
an insulated metal oxide layer formed on the other surface of the substrate.

3. A heater according to claim 2, wherein the insulated metal oxide layer is made of a compound containing one or more selected from a group consisting of silicon oxide (SiO₂), aluminum oxide (Al₂O₃), magnesium oxide (MgO), calcium oxide (CaO), strontium oxide (SrO), barium oxide (BaO) titanium oxide (TiO₂), zirconium oxide (ZrO₂), boron oxide (B₂O₃), and bismuth oxide (Bi₂O₃).

4. An image processing apparatus comprising:
an image processor for forming a toner development on a paper;
a heater; and
a roller having a rubber surface arranged opposite the heater so as to elastically touch it;
wherein the heater comprises: a substrate primarily made of aluminum nitride (AlN), a heat generating member, formed on one surface of the substrate, the heat generating member containing silver (Ag) and palladium (Pd) having a weight ratio (Ag/Pd) in the range of 40/60˜50/50, a pair of conductive electrodes, one being connected to each end of the heat generating member respectively, and
a housing accommodating the image processor, the roller, and the heater.
